(19) United States
(12) Patent Application Publication
(10) Pub. No.: US 2026/0112548 A1
(43) Pub. Date: Apr. 23, 2026

(54) ELECTROCHEMICAL CAPACITOR

(71) Applicant: Panasonic Intellectual Property Management Co., Ltd., Osaka (JP)

(72) Inventors: Tougo ENDOU, Osaka Fu (JP); Nobuhiro SHIMAMURA, Osaka Fu (JP); Kenichi NAGAMITSU, Kyoto Fu (JP); Shohei MASUDA, Hokkaido (JP)

(73) Assignee: Panasonic Intellectual Property Management Co., Ltd., Osaka (JP)

(21) Appl. No.: 19/141,828

(22) PCT Filed: Nov. 6, 2023
(86) PCT No.: PCT/JP2023/039939

§ 371 Date: Jun. 20, 2025

(30) Foreign Application Priority Data
Dec. 23, 2022 (JP) 2022-207302

(51) Int. Cl. H01G 11/50; H01G 11/28

(52) U.S. Cl. CPC H01G 11/50; H01G 11/28

(57) ABSTRACT

A disclosed electrochemical capacitor includes a positive electrode, a negative electrode, a separator, and an electrolyte having lithium ion conductivity. The positive electrode includes a positive electrode current collector and a positive electrode mixture layer that is carried on the positive electrode current collector and that undergoes reversible anion doping. The negative electrode includes a negative electrode current collector and a negative electrode mixture layer that is carried on the negative electrode current collector and that undergoes reversible lithium ion doping. The negative electrode mixture layer contains a negative electrode active material, a conductive agent, a binder, and a dispersant. The ratio of the mass of the dispersant to the mass of the negative electrode mixture layer is greater than the ratio of the mass of the binder to the mass of the negative electrode mixture layer.

### CROSS-REFERENCE TO RELATED APPLICATIONS

The present application is based on and claims priority under 35 U.S.C. § 119 with respect to the Japanese Patent Application No. 2022-207302, filed on Dec. 23, 2022, of which entire content is incorporated herein by reference into the present application.

### TECHNICAL FILED

The present invention relates to an electrochemical capacitor.

### BACKGROUND ART

In recent years, electrochemical capacitors (e.g., hybrid capacitors such as a lithium-ion capacitor) have attracted attention in which energy storage principles of lithium-ion secondary batteries and electric double-layer capacitors are combined. Such an electrochemical capacitor typically uses a polarizable electrode for its positive electrode and a non-polarizable electrode for its negative electrode. As such, the electrochemical capacitors are expected to exhibit both the high energy density of the lithium-ion secondary batteries and the high power characteristics of the electric double-layer capacitors.

Patent Literature 1 proposes “a method of producing a negative electrode active material for lithium-ion capacitor use in which carbon black having an average particle diameter measured by electron microscopy of 12 to 300 nm and a BET specific surface area of 200 to 1500 m²/g is kneaded with a carbon precursor, fired at 800° C. to 3200° C., and pulverized to adjust the average particle diameter (D50) to 1 to 20 μm and the BET specific surface area to 110 m²/g or more and 350 m²/g or less”.

### CITATION LIST

### Patent Literature

Patent Literature 1: Japanese Patent No. 6356145

### SUMMARY OF INVENTION

### Technical Problem

When an electrochemical capacitor such as a lithium-ion capacitor is used at high temperatures over extended periods, a gas may be generated internally through decomposition of a liquid electrolyte. In such an electrochemical capacitor, the generated gas may stagnate between facing electrodes (between positive and negative electrodes) to decrease the facing area, thereby worsening floating characteristics. One objective of the present disclosure is to provide an electrochemical capacitor having favorable floating characteristics.

### Solution to Problem

One aspect of the present invention relates to an electrochemical capacitor including:
a positive electrode; a negative electrode; a separator, and an electrolyte having lithium ion conductivity,
wherein the positive electrode includes a positive electrode current collector and a positive electrode mixture layer that is carried on the positive electrode current collector and that undergoes reversible anion doping,
the negative electrode includes a negative electrode current collector and a negative electrode mixture layer that is carried on the negative electrode current collector and that undergoes reversible lithium ion doping,
the negative electrode mixture layer contains a negative electrode active material, a conductive agent, a binder, and a dispersant, and
a ratio of a mass of the dispersant to a mass of the negative electrode mixture layer is greater than a ratio of a mass of the binder to the mass of the negative electrode mixture layer.

### Advantageous Effects of Invention

According to the present invention, an electrochemical capacitor having favorable floating characteristics can be obtained.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF DRAWING

FIG. 1 is a longitudinal cross-sectional view of the configuration of an electrochemical capacitor according to an embodiment of the present disclosure.

### DESCRIPTION OF EMBODIMENTS

Embodiments of the present disclosure are described below by way of examples, but the present disclosure is not limited to the examples described below. In the following description, specific numerical values and materials may be exemplified in some cases, but other numerical values and other materials may be adopted as long as the effects of the present disclosure can be obtained. In the present description, the phrase “a numerical value A to a numerical value B” means to include the numerical value A and the numerical value B and can be replaced with “a numerical value A or more and a numerical value B or less.” In the following description, when the lower and upper limits of numerical values related to specific physical properties, conditions, or the like are mentioned as examples, any of the mentioned lower limits and any of the mentioned upper limits can be combined in any combination as long as the lower limit is not more than or equal to the upper limit.

The present disclosure encompasses a combination of matters recited in any two or more claims selected from multiple claims in the appended claims. In other words, as long as no technical contradiction arises, matters recited in any two or more claims selected from multiple claims in the appended claims can be combined.

In the following description, the word “comprise” or “include” is an expression including meanings of “comprise (or include),” “essentially consist of,” and “consist of.”

An electrochemical capacitor according to an embodiment of the present invention includes a positive electrode, a negative electrode, a separator, and an electrolyte having lithium ion conductivity. Generally, the positive electrode and the negative electrode constitute an electrode body together with the separator provided therebetween. For example, the electrode body is constituted as a columnar wound body in which the positive electrode in the shape of a band and the negative electrode in the shape of a band are wound with the separator therebetween. Alternatively, the electrode body may be constituted as a stacked body in which the positive electrode in the shape of a plate and the negative electrode in the shape of a plate are stacked with a separator therebetween.

The positive electrode includes a positive electrode current collector and a positive electrode mixture layer that is carried on the positive electrode current collector and that undergoes reversible anion doping. The positive electrode mixture layer contains at least a positive electrode active material that undergoes reversible anion doping. The anion doping into the positive electrode mixture layer or the positive electrode active material is a concept that includes at least a phenomenon of anion adsorption to the positive electrode active material and that can include, for example, a chemical interaction of anions with the positive electrode active material. In the positive electrode mixture layer, at least the non-Faraday reaction (reaction not accompanying oxidation and reduction) in which anions are reversibly adsorbed and desorbed proceeds to express capacity.

The negative electrode includes a negative electrode current collector and a negative electrode mixture layer that is carried on the negative electrode current collector and that undergoes reversible lithium ion doping. The negative electrode mixture layer contains at least a negative electrode active material that undergoes reversible lithium ion doping. The lithium ion doping into the negative electrode mixture layer or the negative electrode active material is a concept that includes at least a phenomenon of lithium ion absorption to the negative electrode active material and that can include, for example, lithium ion adsorption to the negative electrode active material and chemical interaction between the negative electrode active material and lithium ions. In the negative electrode mixture layer, at least the Faraday reaction (reaction accompanied by oxidation and reduction) in which lithium ions are reversibly absorbed and released proceeds to express capacity.

Typical examples of such an electrochemical capacitor include hybrid capacitors such as a lithium-ion capacitor. Typically, the positive electrode of the lithium-ion capacitor is a polarizable electrode. The polarizable positive electrode expresses capacity by anion adsorption and desorption to and from the positive electrode active material. The positive electrode active material contains a carbon material (e.g., activated carbon), for example. However, the positive electrode may be an electrode that has properties of a polarizable electrode and of which Faraday reaction also contributes to the positive electrode capacity. That is, the positive electrode may be an electrode of which capacity is expressed through progress of the Faraday reaction in addition to the non-Faraday reaction. The electrode such as above contains, for example, a x-conjugated conductive polymer as the positive electrode active material. The conductive polymer may be doped with a dopant.

### (Negative Electrode)

As described above, the negative electrode includes a negative electrode current collector and a negative electrode active material layer that is carried on the negative electrode current collector and that undergoes reversible lithium ion doping. The negative electrode mixture layer contains at least a negative electrode active material that undergoers reversible lithium ion doping. The negative electrode active material such as above contains hard carbon (non-graphitizable carbon). The thickness of the negative electrode mixture layer is not particularly limited and may be 10 μm to 300 μm per side of the negative electrode current collector, for example.

As the negative electrode current collector, a sheet-shaped metal material is used. The sheet-shaped metal material may be a metal foil, a porous metal body, or an etched metal, for example. As the metal material, copper, a copper alloy, nickel, or stainless steel can be used, for example.

The non-graphitizable carbon may have a surface spacing (i.e., surface spacing between a carbon layer and a carbon layer) d002 of the (002) plane as measured by X-ray diffractometry of 3.8 Å or more. The theoretical capacity of the non-graphitizable carbon is preferably 150 mAh/g or more, for example. By using the above-mentioned non-graphitizable carbon, it is easy to obtain a negative electrode that has a small low-temperature DCR and exhibits small expansion and contraction in association with charging and discharging. The non-graphitizable carbon occupies desirably 50% by mass or more of the negative electrode active material, more desirably 80% by mass or more, and further desirably 95% by mass or more. In addition, the non-graphitizable carbon occupies desirably 40% by mass or more of the negative electrode mixture layer, more desirably 70% by mass or more, and further desirably 90% by mass or more.

As the negative electrode active material, a combination of the non-graphitizable carbon and a material other than the non-graphitizable carbon may be used. Examples of the material other than the non-graphitizable carbon that can be used as the negative electrode active material include graphitizable carbon (soft carbon), graphite (e.g., natural graphite and artificial graphite), lithium-titanium oxides (e.g., spinel-type lithium-titanium oxide), silicon oxides, silicon alloys, tin oxides, and tin alloys.

From the viewpoint that filling property of the negative electrode active material in the negative electrode mixture layer can be enhanced and side reactions with an electrolyte can be easily suppressed, the average particle diameter of the negative electrode active material (particularly, the non-graphitizable carbon) is preferably 1 μm to 20 μm, and more preferably 2 μm to 15 μm.

In the present specification, the average particle diameter means a volume-based median diameter (D50) in a particle diameter distribution obtained by laser diffraction particle size measurement.

The specific surface area of the negative electrode mixture layer is 10 m²/g or more and 70 m²/g or less. As a result of the specific surface area of the negative electrode mixture layer being 10 m²/g or more, the resistance of the negative electrode is remarkably reduced, thereby remarkably reducing the inner resistance of the electrochemical capacitor. As a result of the specific surface area of the negative electrode mixture layer being 70 m²/g or less, reactivity of the negative electrode is not excessively strong to facilitate suppression of negative electrode degradation. Thus, excellent floating characteristics can be achieved. In particular, the specific surface area of the negative electrode mixture layer is preferably 20 m²/g or more and 60 m²/g or less. A method of measuring the specific surface area of the negative electrode mixture layer will be described later. The floating characteristics refer to an indicator of the degree of degradation of an electrochemical capacitor when subjected to float charging. Here, the float charging is charging using an external DC power supply to maintain a constant voltage. It can be said that the floating characteristics improve as decrease in capacity during float charging is smaller and increase in inner resistance is smaller.

When the negative electrode mixture layer in a conventional electrochemical capacitor has a large specific surface area, the active surface of the negative electrode active material that contributes to the Faraday reaction is excessively exposed, which may involve internal gas generation through decomposition of the liquid electrolyte. As a result, the generated gas stagnates between the facing electrodes (between the positive and the negative electrodes) to decrease the facing area, which may worsen the floating characteristics.

In order to solve such a problem, the present inventors have intensively studied and found that when the negative electrode mixture layer is configured as described below, an electrochemical capacitor having favorable floating characteristics can be obtained even when the negative electrode mixture layer has a large specific surface area.

The negative electrode mixture layer contains a negative electrode active material, a conductive agent, a binder, and a dispersant.

In order to achieve a function as an electrochemical capacitor, the negative electrode mixture layer is bonded desirably in a state where the negative electrode active material and the conductive agent are delocalized in the negative electrode mixture layer.

The dispersant disperses to stabilize a negative electrode slurry in a negative electrode production process. Accordingly, the negative electrode active material and the conductive agent can be homogenized when the negative electrode mixture layer is formed. Further, the dispersant can also act as a binder when excess thereof occurs, and it has less influence on the resistance of the negative electrode mixture layer than the binder.

By contrast, use of only the dispersant does not provide durability sufficient to maintain the binding of the negative electrode mixture layer when the electrochemical capacitor is used at high temperatures (e.g., at 85° C.) over extended periods. In view of the foregoing, the negative electrode mixture layer desirably contains a binder in addition to the dispersant in order to obtain durability. The binder can follow, due to its flexible polymer structure, expansion and contraction of the negative electrode mixture layer in thermal environments in which electrochemical capacitors are used. Thus, binding of the negative electrode mixture layer can be maintained.

In a negative electrode production process, the binder forms an insulative film on the surfaces of the negative electrode active material and the conductive agent. This makes it possible to suppress gas generation due to decomposition of the liquid electrolyte when the negative electrode mixture layer has a large specific surface area. However, when the mass ratio of the binder is excessively large, the resistance of the negative electrode mixture layer may be increased.

The ratio of the mass of the dispersant to the mass of the negative electrode mixture layer is preferably greater than the ratio of the mass of the binder to the mass of the negative electrode mixture layer. For example, the ratio of the mass of the dispersant to the mass of the negative electrode mixture layer is preferably 1.5 times or more and 50 times or less the ratio of the mass of the binder to the mass of the negative electrode mixture layer, and more preferably 2 times or more and 10 times or less.

As a result of the ratios of the mass of the dispersant and the mass of the binder to the mass of the negative electrode mixture layer being set within the above ranges, the resistance of the negative electrode mixture layer can be sufficiently reduced while maintaining strong binding strength. By contrast, when the ratio of the mass of the binder to the mass of the negative electrode mixture layer is greater than the ratio of the mass of the dispersant to the mass of the negative electrode mixture layer, the resistance of the negative electrode mixture layer may become excessively high to worsen the floating characteristics.

The binder contains at least one selected from the group consisting of fluorocarbon resin, acrylic resin, and a rubber material, and may contain styrene-butadiene rubber.

The ratio of the mass of the binder to the mass of the negative electrode mixture layer should be 0.3% or more and less than 5%, and may be 0.5% or more and less than 3.5%, or 1.0% or more and less than 2.0%. When the ratio is within a range such as above, the active surface of the negative electrode active material can be appropriately coated with a film derived from the binder, with a result that gas generation due to decomposition of the liquid electrolyte can be suppressed.

Examples of the binder include fluorocarbon resins, acrylic resins, and rubber materials. Examples of fluorocarbon resins include polytetrafluoroethylene (PTFE), polyvinylidene fluoride (PVDF), modified products of PVDF, tetrafluoroethylene-perfluoroalkyl vinyl ether copolymers (PFA), and tetrafluoroethylene-hexafluoropropylene copolymers (FEP). Examples of the acrylic resins include polyacrylic acid and acrylic acid-methacrylic acid copolymers. Example of the rubber materials include styrene-butadiene rubber.

The dispersant is at least one selected from the group consisting of carboxymethyl cellulose and carboxymethyl cellulose salt (hereinafter, the at least one selected from the group consisting of carboxymethyl cellulose and carboxymethyl cellulose salt is also referred to as “CMC”).

The ratio of the mass of the dispersant (CMC) to the mass of the negative electrode mixture layer is, for example, 1% or more, and may be 3% or more, or 4.5% or more. The ratio of the mass of the dispersant (CMC) to the mass of the negative electrode mixture layer is, for example, 10.0% or less, and may be 8.0% or less, or 6.5% or less. When the ratio is within a range such as above, dispersion stability of the negative electrode slurry can be ensured, and the negative electrode mixture layer can be bonded to the negative electrode current collector with higher strength.

When carboxymethylcellulose salt is used as a CMC, sodium salt, lithium salt, potassium salt, or ammonium salt can be used, for example. Among these, the carboxymethylcellulose salt preferably includes an ammonium salt. The ammonium salt of the carboxymethyl cellulose is particularly preferable because it is less likely to increase the resistance of the negative electrode among the CMCs.

The specific surface area of the negative electrode mixture layer is a BET specific surface area determined using a measuring device (e.g., TriStar II 3020, product of SHIMADZU CORPORATION) conforming to JIS Z8830. Specifically, it is a BET specific surface area determined as follows. First, an electrochemical capacitor is disassembled, and its negative electrode is taken out. A half-cell is assembled using the negative electrode as a working electrode and a Li metallic foil as a counter electrode, and Li in the negative electrode is de-doped until the negative potential reaches 1.5 V. Next, the Li-de-doped negative electrode is washed with dimethyl carbonate (DMC) and dried. Thereafter, the negative electrode mixture layer is peeled off from the negative electrode current collector, and approximately 0.5 g of the negative electrode mixture layer is collected as a sample.

Next, the collected sample is heated at 150° C. for 12 hours under a reduced pressure of 95 kPa or less. Thereafter, nitrogen gas is adsorbed onto the sample of a known mass, and an adsorption isotherm is plotted in the relative pressure range of 0 to 1. Then, the surface area of the sample is calculated from the monolayer adsorption amount of the gas obtained from the adsorption isotherm. Here, the specific surface area is obtained using the following BET equations by the BET single-point method (relative pressure 0.3).

$$P / V ( P 0 - P ) = ( 1 / VmC ) + \{ ( C - 1 ) / VmC \} ( P / P 0 ) \qquad ( 1 )$$

$$S = kVm \qquad ( 2 )$$

P0: saturated vapor pressure
P: adsorption equilibrium pressure
V: adsorption amount at adsorption equilibrium pressure P
Vm: monolayer adsorption amount
C: parameter relating to adsorption heat or the like
S: specific surface area
k: nitrogen monomolecular adsorption area, 0.162 nm²

It is preferable to ensure that the peel strength of the negative electrode mixture layer on the negative electrode current collector is, for example, 0.015 N/mm or more. This level of the peel strength is sufficient in terms of production process and also in view of ensuring product characteristics. For example, by setting the mass ratios of the binder and the CMC to the negative electrode mixture layer to the aforementioned ranges, a peel strength of 0.04 N/mm or more, or even 0.05 N/mm or more, can be ensured while maintaining the product characteristics.

The peel strength of the negative electrode mixture layer on the negative electrode current collector is determined using a measuring device conforming to JIS Z0237 (2009). Specifically, it is determined as follows. First, an electrochemical device is disassembled and its negative electrode is taken out. Next, the negative electrode is washed with dimethyl carbonate (DMC) and dried. Thereafter, the negative electrode is formed into a band-shaped sample having a width of 10 mm and a length of 50 mm or more. Next, one side of a double-sided tape (e.g., No. 5606, product of Nitto Denko Corporation) having a width of 20 mm and a length of 130 mm is attached to the negative electrode mixture layer of the sample. The other side of the double-sided tape is attached to a horizontal platform having a flat surface. Then, one end of the negative electrode current collector in its length direction is fixed using a force gauge and pulled vertically at a rate of 50 mm/min to peel off the negative electrode mixture layer attached to the double-sided tape from the negative electrode current collector. The tension at that time is measured for 15 seconds or more, and the average tension in a continuous 15-second section is calculated.

The negative electrode mixture layer may contain a conductive agent. A carbon material may be used as the conductive agent. The conductive agent may be carbon black or carbon fiber, for example. Examples of the carbon black include acetylene black (AB) and Ketjen black (KB). Among these, it is desirable to use Ketjen Black because it has a large specific surface area.

The specific surface area of the negative electrode mixture layer can reflect the specific surface areas of the negative electrode active material and the conductive agent. Desirably, the specific surface area of the conductive agent is large to some extent. Through use of a conductive agent having a large specific surface area, the specific surface area of the negative electrode mixture layer can be increased, and the resistance of the negative electrode can be easily reduced. The specific surface area of the conductive agent is, for example, preferably 800 m²/g or more, and may be 1000 m²/g or more. Examples of such a conductive agent include carbon black (e.g., Ketjen Black).

It is noted that the volume fractions of the respective negative electrode mixture components, including the conductive agent, in the negative electrode mixture layer can be calculated through observation of a cross section of the negative electrode mixture layer using a scanning electron microscope (SEM). The type, specific surface area, and the like of the conductive agent can be estimated from the obtained volume fractions and the specific surface area of the negative electrode mixture layer. The volume fraction of each negative electrode mixture component is calculated by considering the ratio of the area occupied by the negative electrode mixture component in the cross-sectional image as the volume ratio thereof. The ratio of the area can be obtained by analyzing the SEM image using image analysis software.

The ratio of the mass of the conductive agent to the mass of the negative electrode mixture layer is desirably, for example, 2% or more and less than 15%, and may be 3% or more and 12% or less, or 4% or more and 11% or less. Within a range such as above, the resistance of the negative electrode can be reduced to a sufficiently small value, and excellent floating characteristics can be easily ensured.

The negative electrode mixture layer is formed, for example, by mixing a negative electrode mixture with a dispersion medium to prepare a negative electrode slurry, applying the negative electrode slurry to a negative electrode current collector, and then drying it. The negative electrode mixture contains a negative electrode active material, a binder, and a conductive agent, for example.

The negative electrode mixture layer is pre-doped with lithium ions. As a result of the negative electrode mixture layer being pre-doped with lithium ions, the potential of the negative electrode decreases to increase the potential difference (i.e., voltage) between the positive electrode and the negative electrode, thereby increasing the energy density of the electrochemical capacitor.

The negative electrode potential is, for example, 0.2 V or less on a lithium basis (vs. Li/Li⁺). This negative electrode potential is a negative electrode potential (25° C.) at completion of pre-doping (or during charge). The amount of lithium to be pre-doped is set according to the negative electrode potential in the electrolyte after completion of pre-doping. The amount of lithium to be pre-doped should be, for example, about 50% to 95% of the maximum amount of lithium that can be absorbed in the negative electrode mixture layer.

On the surface of the negative electrode mixture layer, a first layer containing lithium carbonate may be formed. The first layer is formed mainly on at least a part of the surface of the negative electrode active material present on the surface of the negative electrode mixture layer. Typically, the floating characteristics tend to worsen as the specific surface area of the negative electrode mixture layer is increased. However, formation of the first layer can significantly suppress degradation of the negative electrode, with a result that worsening of the floating characteristics is suppressed.

On the surface the negative electrode mixture layer, a second layer containing a solid electrolyte may be formed. At least a part of the second layer can cover at least a part of the surface of the negative electrode mixture layer with the first layer therebetween. The second layer, which has a different composition from that of the first layer, is distinguishable from the first layer. In an electrochemical capacitor utilizing lithium ions, a solid electrolyte interphase film (i.e., a SEI film) is formed on the surface of the negative electrode mixture layer during charging and discharging. The second layer may be formed as the SEI film.

The SEI film plays a significant role in charge and discharge reactions. However, when the formed SEI film is excessively thick, degradation of the negative electrode becomes significant. For example, in an electrochemical capacitor utilizing lithium ions, the SEI film inhibits lithium ion dispersion to increase the inner resistance. However, the first layer containing lithium carbonate has an action of promoting formation of a favorable SEI film and maintaining the SEI film in a favorable condition under repeated charging and discharging. For example, when the thickness of the SEI film is kept relatively constant under repeated charging and discharging, the first layer functions to suppress a large variation in the amount of lithium ions used to form the SEI film. Therefore, as a result of the first layer being formed on the surface of the negative electrode mixture layer, degradation of the negative electrode can be remarkably suppressed even when the specific surface area of the negative electrode mixture layer is increased in order to reduce the resistance of the negative electrode.

When the first layer and the second layer are formed on the surface of the negative electrode mixture layer, at least a part of the second layer covers, via the first layer, at least a part of the surface of the negative electrode active material present on the surface of the negative electrode mixture layer. That is, at least a part of the first layer is covered with the second layer. The first layer is present between the second layer and the surface of the negative electrode active material present on the surface of the negative electrode mixture layer and serves as an underlayer of the second layer. As a result of the first layer serving as an underlayer, the second layer is formed as a SEI film in a good condition.

The second layer can also contain lithium carbonate. When the second layer contains lithium carbonate, the content of the lithium carbonate contained in the second layer is less than the content of the lithium carbonate contained in the first layer. As a result of the first layer, which contains a large amount of lithium carbonate, serving as an underlayer, the second layer is formed as a SEI film in a better condition.

The first layer can be formed on the surface of the negative electrode mixture layer prior to assembling the electrochemical capacitor. In the electrochemical capacitor assembled with the negative electrode included, a homogenous second layer (SEI film) having an appropriate thickness is formed on the surface of the negative electrode active material present on the surface of the negative electrode mixture layer by subsequent charging and discharging. The SEI film is formed by reaction between the electrolyte and the negative electrode in the electrochemical capacitor, for example. Since the electrolyte can pass through not only the second layer but also the first layer, the entire layer including the first layer and the second layer may be referred to as SEI film, but for convenience, the second layer is referred to as SEI film and is distinguished from the first layer in the present specification.

The presence of a region containing lithium carbonate such as the first layer can be confirmed by analyzing the surface of the negative electrode mixture layer by X-ray photoelectron spectroscopy (XPS), for example. Measurement by XPS will be described later. However, the analysis method is not limited to XPS.

The thickness of the first layer should be, for example, 1 nm or more, should be 5 nm or more when a longer-term action is expected, and may be 10 nm or more when a more reliable action is expected. Nevertheless, when the thickness of the first layer exceeds 50 nm, the first layer itself may become a resistance component. Therefore, the thickness of the first layer may be 50 nm or less, or 30 nm or less. The thickness of the first layer is 1 nm to 50 nm, for example.

The thickness of the second layer should be, for example, 1 nm or more, and may be 3 nm or more, with 5 nm or more being sufficient. Nevertheless, when the thickness of the second layer exceeds 20 nm, the second layer itself may become a resistance component. Therefore, the thickness of the second layers may be 20 nm or less, or 10 nm or less.

A ratio: A/B of a thickness A of the first layer to a thickness B of the second layer is preferably 1 or less in view of reducing the resistance of the negative electrode. In this case, the thickness of the second layer is preferably 20 nm or less and may be 10 nm or less. However, in view of forming the second layer in good condition, the ratio A/B is preferably 0.1 or more, and may be 0.2 or more, for example.

The thicknesses of the first layer and the second layer are measured by analyzing the surface of the negative electrode mixture layer at multiple locations (at least 5 locations) of the negative electrode mixture layer. The average thickness of the first layer or the second layer obtained at the locations should be the thickness of the first layer or the second layer. The negative electrode mixture layer to be used as a measurement sample may be one peeled off from the negative electrode current collector. In this case, the film formed on the surface of the negative electrode active material constituting the vicinity of the surface of the negative electrode mixture layer should be analyzed. Specifically, the negative electrode active material covered with the film should be collected from the vicinity of the surface of the negative electrode mixture layer located opposite to the side bonded to the negative electrode current collector and used for analysis.

The XPS spectrometry of the surface of the negative electrode mixture layer is performed, for example, by irradiating the film formed on the surface of the negative electrode mixture layer or the surface of the negative electrode active material present on the surface of the negative electrode mixture layer with an argon beam in a chamber of an X-ray photoelectron spectrometer, and observing and recording changes in spectra attributed to, for example, C1s and O1s electrons during irradiation time. At that time, the spectrum of the outermost surface of the film may be ignored in order to avoid analysis errors. The thickness of a region where a peak attributed to lithium carbonate is stably observed corresponds to the thickness of the first layer.

In a negative electrode taken out of an electrochemical capacitor that has been fully assembled and undergone predetermined aging or at least one cycle of charging and discharging, the SEI film (i.e., the second layer) containing the solid electrolyte is formed on the surface of the negative electrode mixture layer. The thickness of a region where a peak attributed to a bond of a compound contained in the SEI film is stably observed corresponds to the thickness of the SEI film (i.e., the thickness of the second layers).

As the compound contained in the SEI film, a compound containing an element that can serve as a marker for the second layer is selected. The element that can serve as a marker for the second layer should be selected from elements (e.g., F) that are contained, for example, in the electrolyte but not substantially in the first layer. For example, LiF can be selected as the compound containing an element that can serve as a marker for the second layer.

When the second layer contains LiF, a substantial peak of F1s attributed to a LiF bond is observed through measurement of the second layer by X-ray photoelectron spectroscopy (XPS). The thickness of a region where the peak attributed to a LiF bond is stably observed corresponds to the thickness of the second layers.

By contrast, the first layer typically does not contain LiF. As such, no substantial peak of F1s attributed to a LiF bond is observed when the first layer is measured by X-ray photoelectron spectroscopy (XPS). Therefore, the thickness of the first layer may be the thickness of a region where a peak attributed to a LiF bond is not stably observed.

In the SEI film, a peak of O1s attributed to lithium carbonate can also be observed. However, since the SEI film generated in an electrochemical capacitor differs in composition from the pre-formed first layer, they can be distinguished from each other. For example, in XPS spectrometry of the SEI film, a peak of F1s attributed to a LiF bond is observed, but no substantial peak of F1s attributed to the LiF bond is observed in the first layer. In addition, the amount of lithium carbonate contained in the SEI film is trace amount. As the peak of Li1s, a peak derived from a compound such as ROCO₂Li or ROLi can be detected, for example.

When analyzing the first layer by XPS, a second peak corresponding to Ols attributed to a Li—O bond may be observed other than a first peak corresponding to O1s attributed to a C═O bond. The region of the film that is present in the vicinity of the surface of the negative electrode active material may contain a trace amount of LiOH or Li₂O.

Specifically, when analysis in the depth direction is performed on the first layer formed on the surface of the negative electrode mixture layer, the first peak (O1s attributed to C—O bond) and the second peak (O1s attributed to Li—O bond) may be observed in the order of increasing depth from the outermost surface of the first layer. Further, a first region and a second region may be observed. Here, the first regio is a region where a first peak intensity (peak intensity of first peak) is larger than a second peak intensity (peak intensity of second peak), and the second region is a region where the first peak and the second peak are observed and the second peak intensity is larger than the first peak intensity. In addition, a third region where the first peak is observed while the second peak is not observed may be additionally present between the first region and the outermost surface of the first layer. The third region tends to be observed when a region containing lithium carbonate has a large thickness.

The magnitude relationship between the first peak intensity and the second peak should be determined according to the height of each peak from the baseline.

Usually, the peak of C1s attributed to a C—C bond is not substantially observed in the middle of the first layer in the thickness direction. Even if observed, its intensity is less than half of that of a peak attributed to a C═O bond.

Next, a method of forming a first layer containing lithium carbonate on the surface of the negative electrode mixture layer will be described. The process of forming the first layer may be performed by a vapor phase method, a coating method, or a transfer method, for example.

Examples of the vapor phase method include chemical vapor deposition, physical vapor deposition, and sputtering. For example, lithium carbonate should be deposited on the surface of the negative electrode mixture layer using a vacuum-deposition device. The pressure in the device chamber during vapor deposition should be 10⁻² to 10⁻⁵ Pa, for example. The temperature of a lithium carbonate evaporation source should be 400 to 600° C. The temperature of the negative electrode mixture layer should be −20 to 80° C.

Regarding the coating method, the first layer can be formed by coating a solution or a dispersion liquid containing lithium carbonate on the surface of the negative electrode mixture layer using, for example, a microgravure coater, followed by drying. The content of the lithium carbonate in the solution or the dispersion liquid is 0.3 to 2% by mass, for example. When the solution is used, its concentration should be a concentration (e.g., about 0.9 to 1.3% by mass in a case of an aqueous solution at room temperature) not exceeding its solubility.

Further, the negative electrode can be obtained by performing a process of forming a second layer containing a solid electrolyte so as to cover at least a part of the first layer. The first layer and the second layer are formed on the surface of the negative electrode mixture layer thus obtained. The second layer is formed such that at least a part thereof covers, via the first layer (i.e., using the first layer as an underlayer), at least a part of the surface of the negative electrode active material present on the surface of the negative electrode mixture layer. Preferably, the second layer is formed to cover the entire surface of the negative electrode mixture layer via the first layer.

The process of forming the second layer may serve also as at least a part of the process of pre-doping lithium ions into the negative electrode mixture layer because the process of forming the second layer is performed in a state in which the electrolyte is in contact with the negative electrode mixture layer with the first layer formed thereon. For example, metal lithium may be used as a source of lithium ions to be pre-doped.

The metal lithium may be deposited on the surface of the negative electrode mixture layer. When the negative electrode including the negative electrode mixture layer on which the metal lithium is deposited is exposed to a carbon dioxide atmosphere, a first layer containing lithium carbonate and having a thickness of, for example, 1 nm or more and 50 nm or less can be formed on the surface of the negative electrode mixture layer.

The process of depositing metal lithium on the surface of the negative electrode mixture layer can be performed by a vapor phase method or transfer, for example. Examples of the vapor phase method include chemical vapor deposition, physical vapor deposition, and sputtering. For example, metal lithium should be formed into a film on the surface of the negative electrode mixture layer using a vacuum-deposition device. The pressure in the device chamber during vapor deposition should be 10⁻² to 10⁻⁵ Pa, for example. The temperature of a lithium evaporation source should be 400 to 600° C. The temperature of the negative electrode mixture layer should be −20 to 80° C.

The carbon dioxide atmosphere is desirably a dry atmosphere containing no moisture and its dew point should be −40° C. or lower or −50° C. or lower, for example. The carbon dioxide atmosphere can contain a gas other than carbon dioxide, but the mole fraction of the carbon dioxide is desirably 80% or more, and more desirably 95% or more. Desirably, the carbon dioxide atmosphere does not contain an oxidizing gas. In the carbon dioxide atmosphere, the mole fraction of oxygen should be 0.1% or less.

In order to form the first layer thicker, it is efficient to set the partial pressure of carbon dioxide greater than 0.5 atmospheres (5.05×10⁴ Pa), for example. It may be 1 atmosphere (1.01×105 Pa) or more.

The temperature of the negative electrode exposed to the carbon dioxide atmosphere should be 15° C. to 120° C., for example. The higher the temperature, the thicker the first layer.

The thickness of the first layer can be easily controlled by changing the duration of exposure of the negative electrode to the carbon dioxide atmosphere. The exposure duration should be, for example, 12 hours or more, and should be less than 10 days.

The process of forming the first layer is desirably performed before assembling the electrode body but does not exclude a case where the process is performed after assembling the electrode body. That is, the first layer may be formed on the surface of a negative electrode mixture layer in a manner that: a positive electrode is prepared: a negative electrode including the negative electrode mixture layer with metal lithium deposited therein is prepared: an electrode body is formed by interposing a separator between the positive electrode and the negative electrode; and then the electrode body is exposed to the carbon dioxide atmosphere.

The process of pre-doping lithium ions into the negative electrode mixture layer proceeds, for example, by bringing the negative electrode mixture layer into contact with an electrolyte after the electrode body is formed as described above and is completed by leaving the electrode body for a predetermined period of time. Such a process can be a process of forming the second layer so as to cover at least a part of the first layer. For example, by performing a cycle of charging and discharging of the electrochemical capacitor at least one time, the second layer can be formed on the negative electrode mixture layer and pre-doping of lithium ions into the negative electrode mixture layer can be completed. Alternatively, pre-doping of lithium ions into the negative electrode mixture layer can be completed, for example, by applying a predetermined charge voltage (e.g., 3.4 to 4.0 V) between the terminals of the positive electrode and the negative electrode for a predetermined time (e.g., 1 to 75 hours).

### (Positive Electrode)

The positive electrode contains a positive electrode active material that undergoes reversible anion doping. The positive electrode active material is a carbon material or a conductive polymer, for example. The positive electrode may include a positive electrode mixture layer containing the positive electrode active material and a positive electrode current collector carrying the positive electrode mixture layer. The thickness of the positive electrode mixture layer is not particularly limited and is from 10 to 300 μm per side of the positive electrode current collector, for example.

For the positive electrode current collector, a sheet-shaped metal material is used. The sheet-shaped metal material should be a metal foil, a porous metal body, or an etched metal, for example. As the metal material, aluminum, an aluminum alloy, nickel, or titanium can be used, for example.

As the carbon material used as the positive electrode active material, a porous carbon material is preferable, and activated carbon is desirable. Examples of the raw material of the activated carbon include wood, coconut shell, coal, pitch, and phenolic resin. The activated carbon is preferably one subjected to activation treatment.

The average particle diameter of the activated carbon is not particularly limited, and is preferably 20 μm or less, and more preferably 3 μm to 15 μm.

The specific surface area of the positive electrode mixture layer generally reflects the specific surface area of the positive electrode active material. The specific surface area of the positive electrode mixture layer should be, for example, 600 m²/g or more and 4000 m²/g or less, and is preferably 800 m²/g or more and 3000 m²/g or less.

The specific surface area of the positive electrode mixture layer is a BET specific surface area obtained by using a measuring device (e.g., TriStar II 3020, product of SHIMADZU CORPORATION) conforming to JIS Z8830. Specifically, an electrochemical capacitor is disassembled, and its positive electrode is taken out. Next, the positive electrode is washed with DMC and dried. Thereafter, the positive electrode mixture layer is peeled off from the positive electrode current collector and approximately 0.5 g of a sample of the positive electrode mixture layer is collected. Next, the specific surface area of the collected sample is determined according to the above-described method of measuring the specific surface area of the negative electrode mixture layer.

The activated carbon preferably occupies 50% by mass or more of the positive electrode active material, more preferably 80% by mass or more, and further preferably 95% by mass or more. The activated carbon preferably occupies 40% by mass or more of the positive electrode mixture layer, more preferably 70% by mass or more, and further preferably 90% by mass or more.

The positive electrode mixture layer contains the positive electrode active material as an essential component, and optionally contains, for example, a conductive agent, a binder, and a dispersant. Examples of the conductive agent include carbon black and carbon fiber. Examples of the binder include fluorocarbon resins, acrylic resins, and rubber materials. Examples of the dispersant include cellulose derivatives.

The positive electrode mixture layer is formed, for example, by mixing a positive electrode mixture containing the positive electrode active material, the conductive agent, and the like with a dispersion medium to prepare a positive electrode slurry, applying the positive electrode slurry to a positive electrode current collector, and then drying.

The conductive polymer that can be used as the positive electrode active material is preferably a n-conjugated polymer. Examples of the x-conjugated polymer that can be used include polypyrrole, polythiophene, polyfuran, polyaniline, polythiophene vinylene, polypyridine, and derivatives of these. These may be used singly or in combination of two or more. The weight average molecular weight of the conductive polymer is 1000 to 100,000, for example. The I-conjugated polymer derivatives mean polymers whose basic backbone is a x-conjugated polymer such as polypyrrole, polythiophene, polyfuran, polyaniline, polythiophene vinylene, or polypyridine. For example, polythiophene derivatives include poly(3,4-ethylenedioxythiophene) (PEDOT).

The conductive polymer is formed, for example, by immersing a positive electrode current collector including a carbon layer in a reaction liquid containing a raw material monomer of the conductive polymer to electropolymerize the raw material monomer in the presence of the positive electrode current collector. In electropolymerization, the positive electrode current collector and a counter electrode should be immersed in the reaction liquid containing the raw material monomer, and a current should be allowed to flow between them using the positive electrode current collector as an anode. The conductive polymer may be formed by a method other than electropolymerization. For example, the conductive polymer may be formed by chemical polymerization of the raw material monomer. In chemical polymerization, the raw material should be polymerized, for example, with an oxidizer in the presence of the positive electrode current collector.

The raw material monomer used in electropolymerization or chemical polymerization should be any polymerizable compound capable of forming the conductive polymer by polymerization. The raw material monomer may contain an oligomer. Examples of the raw material monomer include aniline, pyrrole, thiophene, furan, thiophene vinylene, pyridine, and derivatives of these. These may be used singly or in combination of two or more. Among these, aniline is easily grown on the surface of a carbon layer by the electropolymerization.

The electropolymerization or the chemical polymerization can be performed with a reaction solution containing anions (dopant). Through doping a dopant into a π-electron conjugated polymer, excellent conductivity is exhibited. Examples of the dopant include sulfate ion, nitrate ion, phosphate ion, borate ion, benzene sulfonate ion, naphthalene sulfonate ion, toluene sulfonate ion, methanesulfonate ion, perchlorate ion, tetrafluoroborate ion, hexafluorophosphate ion, and fluoro sulfate ion. The dopant may be a polymer ion. Examples of the polymer ion include ions of polyvinylsulfonic acid, polystyrene sulfonic acid, polyallylsulfonic acid, polyacrylic sulfonic acid, polymethacrylsulfonic acid, poly(2-acrylamido-2-methylpropane sulfonic acid), polyisoprenesulfonic acid, and polyacrylic acid.

### (Separator)

The separator is provided between the positive electrode and the negative electrode. The separator preferably contains an olefin-based resin, for example. Hereinafter, a separator containing an olefin-based resin is also referred to as “olefin-based separator.”

In an electrochemical capacitor such as a lithium-ion capacitor, a cellulose-based separator is used typically. This is because the cellulose-based separator has excellent electrolyte permeability and tends to allow pre-doping to proceed. However, the cellulose-based separator has a functional group that easily reacts with lithium ions, such as an OH group, and tends to contain moisture. Therefore, the cellulose-based separator is easily damaged by side reactions. Lithium pre-doped in the negative electrode (in detail, the negative electrode mixture layer) may react with the separator to reduce the amount of pre-doped lithium. In an environment in which lithium carbonate is generated on the surface of the negative electrode mixture layer, the cellulose-based separator tends to degrade severely.

By contrast, the olefin-based separator, which has less content of moisture, can suppress degradation of the separator itself and degradation of the negative electrode (in detail, the negative electrode mixture layer) due to the presence of moisture. The olefin-based separator is also excellent in stability against pre-doped lithium and an electrolyte containing lithium ions. The olefin-based separator does not easily degrade even in environments in which lithium carbonate is generated on the surface of the negative electrode mixture layer. Therefore, through use of the olefin-based separator, the inner resistance is kept low for a long period of time. As a result, the floating characteristics of the electrochemical capacitor improve.

When lithium ion pre-doping is performed in a state of a wound body including the positive electrode and the negative electrode, which are wound with the separator therebetween, lithium ions eluted from the metal lithium introduced for pre-doping hardly diffuse to the entire wound body. In this case, it is difficult to use the olefin-based separator. However, pre-doping into the entire winding body can be done in a short time by pre-doping in a state where the electrolyte is brought into contact with the negative electrode including a negative electrode mixture layer with metal lithium pre-deposited on its entire surface.

The olefin-based resin is a resin containing an olefin unit as a main component. The olefin-based resin contains, for example, 50% by mass or more, or 70% by mass or more of the olefin units. The olefin unit refers to a monomer unit derived from an olefin (alkene) such as ethylene, propylene, or butene. Here, a divalent group (diyl group) formed by monomer polymerization is referred to as “unit” of the monomer. At least a portion of the olefin may be a derivative thereof. The olefin-based resin may be homopolymer or a copolymer synthesized from a plurality of olefins. Some of the hydrogen atoms of the olefin may each be substituted with a halogen atom. Examples of the olefin-based resin include polyethylene (PE), polypropylene (PP), polymethylpentene (PMP), chlorinated polyethylene (CPE), ethylene-vinyl acetate copolymers (EVA), and ethylene-ethyl acrylate copolymers (EEA). Among these, at least one selected from the group consisting of polypropylene (PP) and polyethylene (PE) is preferably included. Since a PP separator and a PE separator have high strength and are stable against an electrolyte containing lithium ions, they can be preferably used for an electrochemical capacitor in which the first layer and the second layer are formed on the surface of the negative electrode mixture layer.

As the separator (olefin-based separator) containing an olefin-based resin, a microporous film, a woven fabric, or a nonwoven fabric made of polyolefin can be used, for example. Among these, a microporous film which is a non-fibrous porous film has high strength and is suitable for thinning. The thickness of the separator is, for example, 8 to 40 μm, preferably 12 to 30 μm, and more preferably 14 to 25 μm or 16 to 25 μm.

### (Electrolyte)

The electrolyte having lithium ion conductivity contains a lithium salt and a solvent that dissolves the lithium salt. The anions of the lithium salt reversibly undergo repeated doping and de-doping into and from the positive electrode (in detail, the positive electrode active material layer). Lithium ions derived from the lithium salt are reversibly absorbed and released to and from the negative electrode (in detail, the negative electrode active material layer).

Examples of the lithium salt include LiClO₄, LiBF₄, LiPF₆, LiAlCl₄, LiSbF₆, LiSCN, LiCF₃SO₃, LiFSO₃, LiCF₃CO₂, LiAsF₆, LiB₁₀Cl₁₀, LiCl, LiBr, LiI, LiBCl₄, LiN(SO₂F)₂, and LiN(SO₂CF₃)₂. These may be used singly or in combination of two or more. Among these, a lithium salt having a fluorine-containing anion is preferable in view of obtaining a liquid electrolyte with a high degree of dissociation and low viscosity, as well as improving withstand voltage characteristics of the electrochemical capacitor.

The electrolyte preferably includes an imide-based electrolyte. The imide-based electrolyte contains an imide-based anion as an anion of lithium salt. The imide-based anion may be an anion containing fluorine and sulfur. In particular, lithium bis(fluorosulfonyl)imide, that is, LIN(SO₂F)₂ (LiFSI) is preferably used. For example, 80% by mass or more of the lithium salt may be LiFSI.

It is considered that LiFSI is effective in inhibiting degradation of the positive electrode active material and the negative electrode active material. Among salts having a fluorine-containing anion, FSI anion is excellent in stability. Therefore, it is unlikely to generate by-products and is considered to contribute to smooth charging and discharging without damaging the surface of the active materials. In addition, the SEI film formed of LiFSI on the surface of the negative electrode mixture layer contains a large amount of lithium fluoride, which can reduce the content ratio of lithium carbonate. Thus, a stable second layer containing lithium fluoride as a main component can be formed so as to cover the first layer containing lithium carbonate as a main component.

The concentration of the lithium salt in the non-aqueous electrolyte during charging (charge rate (SOC) 90 to 100%) is 0.2 to 5 mol/L, for example.

Examples of the solvent that can be used include cyclic carbonates such as ethylene carbonate, propylene carbonate, and butylene carbonate, linear carbonates such as dimethyl carbonate, diethyl carbonate, and ethyl methyl carbonate, aliphatic carboxylic acid esters such as methyl formate, methyl acetate, methyl propionate, and ethyl propionate, lactones such as γ-butyrolactone and γ-valerolactone, linear ethers such as 1,2-dimethoxyethane (DME), 1,2-diethoxyethane (DEE), and ethoxy methoxy ethane, cyclic ethers such as tetrahydrofuran and 2-methyltetrahydrofuran, dimethyl sulfoxide, 1,3-dioxolane, formamide, acetamide, dimethylformamide, dioxolane, acetonitrile, propionitrile, nitromethane, ethylmonoglyme, trimethoxymethane, sulfolane, methylsulfolane, and 1,3-propanesarton. These may be used singly or in combination of two or more.

The electrolyte may contain various additives as necessary. For example, an unsaturated carbonate such as vinylene carbonate, vinyl ethylene carbonate, or divinylethylene carbonate may be added as an additive for forming a lithium ion conductive film on the surface of the negative electrode.

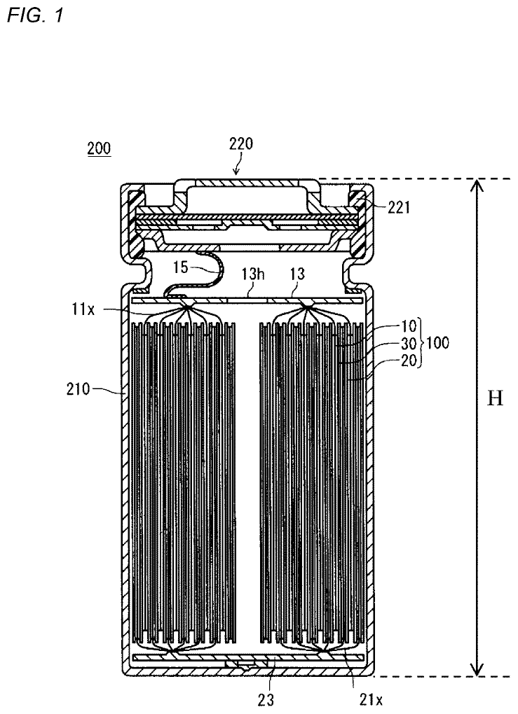

FIG. 1 schematically illustrates the configuration of an electrochemical capacitor 200 according to an embodiment of the present invention. The electrochemical capacitor 200 includes an electrode body 100, a liquid electrolyte (not illustrated) having lithium ion conductivity, a metal-made bottomed cell case 210 that houses the electrode body 100 and the electrolyte, and a sealing plate 220 that seals the opening of the cell case 210. The electrode body 100 is configured as a columnar wound body in which a band-shaped positive electrode 10 and a band-shaped negative electrode 20 are wound with a separator 30 between the positive electrode 10 and the negative electrode 20. A gasket 221 is disposed around the periphery of the sealing plate 220. The inside of the cell case 210 is sealed by crimping the open end of the cell case 210 to the gasket 221.

The positive electrode 10 and the negative electrode 20 have current collector exposed portions at their longitudinal ends, which protrude from different end surfaces of the winding body. An exposed portion 11x of the positive electrode current collector is welded to a positive electrode current collector plate 13 having a through-hole 13h in the center thereof. One end of a tab lead 15, the other end of which is connected to the positive electrode current collector plate 13, is connected to the inner surface of the sealing plate 220. In the above configuration, the sealing plate 220 has a function as an external positive electrode terminal. On the other hand, an exposed portion 21x of the negative electrode current collector is welded to a negative electrode current collector plate 23. The negative electrode current collector plate 23 is directly welded to a welding member provided on the inner bottom surface of the cell case 210. In the above configuration, the cell case 210 has a function as an external negative electrode terminal.

The positive electrode current collector plate 13 and the negative electrode current collector plate 23 are substantially disk-shaped metal plates. The material of the negative electrode current collector plate 23 is copper, a copper alloy, nickel, or stainless steel, for example. The material of the positive electrode current collector plate 13 is aluminum, an aluminum alloy, titanium, or stainless steel, for example.

The electrochemical capacitor is not limited to the wound electrochemical capacitor illustrated in FIG. 1. For example, it may be a stacked electrochemical capacitor. That is, the electrode body may be configured as a stacked body in which a sheet-shaped positive electrode and a sheet-shaped negative electrode are stacked with a separator placed between the positive electrode and the negative electrode.

### SUPPLEMENTAL REMARKS

According to the above description, the following techniques are disclosed.

### Technique 1

An electrochemical capacitor including:
a positive electrode: a negative electrode: a separator, and an electrolyte having lithium ion conductivity,
wherein the positive electrode includes a positive electrode current collector and a positive electrode mixture layer that is carried on the positive electrode current collector and that undergoes reversible anion doping,
the negative electrode includes a negative electrode current collector and a negative electrode mixture layer that is carried on the negative electrode current collector and that undergoes reversible lithium ion doping,
the negative electrode mixture layer contains a negative electrode active material, a conductive agent, a binder, and a dispersant, and
a ratio of a mass of the dispersant to a mass of the negative electrode mixture layer is greater than a ratio of a mass of the binder to the mass of the negative electrode mixture layer.

### Technique 2

The electrochemical capacitor according to Technique 1, wherein the binder is at least one selected from the group consisting of fluorocarbon resin, acrylic resin, and a rubber material.

### Technique 3

The electrochemical capacitor according to Technique 1 or 2, wherein the binder contains styrene-butadiene rubber.

### Technique 4

The electrochemical capacitor according to any one of Techniques 1 to 3, wherein the ratio of the mass of the binder to the mass of the negative electrode mixture layer is 0.3% or more and less than 5%.

### Technique 5

The electrochemical capacitor according to any one of Techniques 1 to 4, wherein the dispersant is at least one selected from the group consisting of carboxymethylcellulose and carboxymethylcellulose salt.

### Technique 6

The electrochemical capacitor according to any one of Techniques 1 to 5, wherein the dispersant contains an ammonium salt of carboxymethylcellulose.

### Technique 7

The electrochemical capacitor according to any one of Techniques 1 to 6, wherein the ratio of the mass of the dispersant to the mass of the negative electrode mixture layer is 1% or more and less than 10%.

### Technique 8

The electrochemical capacitor according to any one of Techniques 1 to 7, wherein the ratio of the mass of the dispersant to the mass of the negative electrode mixture layer is 3% or more and less than 8%.

### Technique 9

The electrochemical capacitor according to any one of Techniques 1 to 8, wherein a specific surface area of the negative electrode mixture layer is 10 m²/g or more and 70 m²/g or less.

### Technique 10

The electrochemical capacitor according to any one of Techniques 1 to 9, wherein the negative electrode mixture layer contains as the conductive agent at least one selected from the group consisting of Ketjen black, acetylene black, and carbon nanotubes.

### Technique 11

The electrochemical capacitor according to any one of Techniques 1 to 10, wherein a ratio of a mass of the conductive agent to the mass of the negative electrode mixture layer is 2% or more and less than 15%.

### Technique 12

The electrochemical capacitor according to any one of Techniques 1 to 11, wherein a specific surface area of the conductive agent is 800 m²/g or more.

### Technique 13

The electrochemical capacitor according to any one of Techniques 1 to 12, wherein the negative electrode active material contains hard carbon.

### Technique 14

The electrochemical capacitor according to any one of Techniques 1 to 13, wherein a peel strength of the negative electrode mixture layer on the negative electrode current collector is 0.015 N/mm or more.

Although the present invention has been described in view of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted to cover all alterations and modifications as fall within the true spirit and scope of the invention.

### EXAMPLES

Hereinafter, the present invention will be specifically described based on examples. However, the present invention is not limited to the following examples.

### (Electrochemical Capacitors A1 to A7, B1, and B2)

### (1) Positive Electrode Production

An aluminum foil (positive electrode current collector) having a thickness of 30 μm was prepared. Meanwhile, a positive electrode slurry was prepared by dispersing in water 88 parts by mass of activated carbon (average particle diameter 5.5 μm) being a positive electrode active material, 6 parts by mass of acetylene black (AB) being a conductive agent, 4 parts by mass of carboxymethyl cellulose (CMC) being a dispersant, and 2 parts by mass of polytetrafluoroethylene (PTFE) being a binder. The resulting positive electrode slurry was applied to both sides of the aluminum foil, and the resulting film was dried and rolled to form a positive electrode mixture layer. Thus, a positive electrode was obtained. A positive electrode current collector exposed portion having a width of 10 mm was formed at an end of the positive electrode current collector in the longitudinal direction.

### (2) Negative Electrode Production

A copper foil (negative electrode current collector) having a thickness of 10 μm was prepared. Meanwhile, a negative electrode slurry was prepared by dispersing a negative electrode active material, a conductive agent, a binder, and a dispersant in water so as to achieve any of the blending ratios shown in Table 1. The resulting negative electrode slurry was applied to both sides of the copper foil, and the resulting film was dried and rolled to form a negative electrode mixture layer. Thus, negative electrodes were obtained. For the negative electrode active material, graphite carbon (HC: average particle diameter 5 μm) was used. Note that Ketjen Black (KB) was used as the conductive agent, an ammonium salt of carboxymethyl cellulose (CMC) was used as the dispersant, and styrene-butadiene rubber (SBR) was used as the binder. The specific surface area of the negative electrode mixture layer was adjusted to any of the values shown in Table 1 by changing the blending ratio between the negative electrode active material and the conductive agent Thereafter, a thin film of metal lithium for pre-doping was formed on the entire surface of the negative electrode mixture layer by vacuum vapor deposition. The amount of lithium to be pre-doped was set so that the negative electrode potential in the electrolyte after completion of the pre-doping reached 0.2 V or less relative to the metallic lithium.

Thereafter, the inside of the chamber of the device was purged with carbon dioxide to establish a carbon dioxide atmosphere, thereby forming a first layer containing lithium carbonate on the surface of the negative electrode mixture layer. The dew point of the carbon dioxide atmosphere was set to −40° C. The molar fraction of the carbon dioxide was set to 100%. The internal pressure of the chamber was set to 1 atmosphere (1.01×10⁵ Pa). The temperature of the negative electrode exposed to the carbon dioxide atmosphere at 1 atmosphere was set to 25° C. The negative electrode was exposed to the carbon dioxide atmosphere for 22 hours. The first layer is substantially free of F (or LiF).

The peel strength of the negative electrode mixture layer on the negative electrode current collector was measured to be 0.04 N/mm or more.

### (Electrode Body Production)

As a separator, a single-layer microporous polypropylene (PP) film (thickness: 25 μm) being an olefin-based separator was used.

The positive electrode and any of the negative electrodes were wound into a columnar shape with the separator therebetween to form an electrode body. At that time, the exposed portion of the positive electrode current collector was protruded from one end surface of the electrode body, and the exposed portion of the negative electrode current collector was protruded from the other end surface of the electrode body. A disk-shaped positive electrode current collector plate and a disk-shaped negative electrode current collector plate were welded to the exposed portion of the positive electrode current collector and the exposed portion of the negative electrode current collector, respectively.

### (Electrolyte Preparation)

LiFSI as a lithium salt was dissolved in a mixed solvent (volume ratio: 3:5:2) of ethylene carbonate (EC), ethyl methyl carbonate (EMC), and diethyl carbonate (DEC) to prepare a non-aqueous electrolyte. The concentration of LiFSI in the non-aqueous electrolyte was set to 1.2 mol/L.

### (Electrochemical Capacitor Assembly)

Any of the electrode bodies was housed in a bottomed cell case having an opening, a tab lead connected to the positive electrode current collector plate was connected to the inner surface of a sealing plate, and the negative electrode current collector plate was welded to the inner bottom surface of the cell case. The non-aqueous electrolyte was injected into the cell case, and the opening of the cell case was sealed with the sealing plate, thereby assembling an electrochemical capacitor as illustrated in FIG. 1. In Table 1, A1 to A10 are electrochemical capacitors of Example 1 to 10, respectively, and B1 and B2 are electrochemical capacitors of Comparative Examples 1 and 2, respectively.

Thereafter, aging was performed at 60° C. while applying a charge voltage of 3.8 V between the terminals of the positive electrode and the negative electrode to complete lithium ion pre-doping into the negative electrode (in detail, the negative electrode active material layer).

Each of the electrochemical capacitors of Examples and Comparative Examples was evaluated as follows.

### [Evaluation 1: Evaluation of Reliability (Floating Characteristics) of Electrochemical Capacitor]

The electrochemical capacitor immediately after the aging was subjected to constant current charging at a current density of 2 mA/cm² per area of the positive electrode in an environment at −30° C. until the voltage reached 3.8 V, and then held for 10 minutes in a state where a voltage of 3.8 V was applied. Thereafter, constant current discharging was performed at a current density of 2 mA/cm² per area of the positive electrode in an environment at −30° C. until the voltage reached 2.2 V.

A height H1 (mm) of the electrochemical capacitor at that time was measured using a caliper. The height of the electrochemical capacitor is the maximum axial dimension H of the main body of the cylindrical electrochemical capacitor 200 illustrated in FIG. 1.

Next, the electrochemical capacitor was held in a state where a constant voltage of 3.8 V was applied in an environment at 85° C. for a long time. After an elapse of 1000 hours, the electrochemical capacitor was taken out. Thereafter, constant current discharging was performed at a current density of 2 mA/cm² per area of the positive electrode in an environment at −30° C. until the voltage reached 2.2 V. A height H2 (mm) of the electrochemical capacitor at that time was measured using a caliper.

A value obtained by subtracting H1 from H2 was determined as a swell (mm) of the electrochemical capacitor. A small swell indicates suppression of gas generation during float charging. When the value of the swell falls within the range of less than 0.6 (mm), the floating characteristics are good.

The evaluation results are shown in Table 1.

TABLE 1

| | Specific | | | | | |
|---|---|---|---|---|---|---|
| | surface | Conductive | Active | | | |
| | area | agent | material | Binder | Dispersant | Swell |
| | (m²/g) | (part by mass) | (part by mass) | (part by mass) | (part by mass) | (mm) |
| B1 | 24 | 10.0 | 85.0 | 0.0 | 5.0 | 0.61 |
| B2 | 24 | 10.0 | 85.5 | 4.5 | 0.0 | — |
| A1 | 24 | 10.0 | 84.9 | 0.1 | 5.0 | 0.59 |
| A2 | 24 | 10.0 | 84.0 | 1.0 | 5.0 | 0.43 |
| A3 | 24 | 10.0 | 77.5 | 4.5 | 8.0 | 0.12 |
| A4 | 24 | 10.0 | 73.0 | 6.0 | 11.0 | 0.09 |
| A5 | 10 | 2.0 | 92.9 | 0.1 | 5.0 | 0.12 |
| A6 | 50 | 12.0 | 82.9 | 0.1 | 5.0 | 0.58 |
| A7 | 50 | 12.0 | 82.0 | 1.0 | 5.0 | 0.57 |
| A8 | 20 | 9.0 | 82.0 | 4.0 | 5.0 | 0.11 |
| A9 | 40 | 9.0 | 85.9 | 0.1 | 5.0 | 0.5 |
| A10 | 10 | 9.0 | 85.9 | 0.1 | 5.0 | 0.12 |

In the electrochemical capacitor B1, the amount of generated gas was very large, and the floating characteristics were unsatisfactory. In the electrochemical capacitor B2, the negative electrode slurry could not be applied to the negative electrode current collector due to its poor dispersibility. By contrast, in the electrochemical capacitors A1 to A10, the amount of decomposition gas generated was small, and the floating characteristics were good. Details of the electrochemical capacitors A8 to A10 will be described later.

Furthermore, a comparison of the electrochemical capacitors A1 to A4 with B1 confirmed that the use of the binder reduced the amount of generated gas and resulted in good floating characteristics when the specific surface areas of the negative electrode mixture layers and the blending ratios of the conductive agent in the negative electrode mixture layers were the same.

### <<Electrochemical Capacitor A8>>

The electrochemical capacitor A8 was produced and evaluated in the same manner as for the electrochemical capacitors A1 to A7, except that 91 parts by mass of a total of the negative electrode active material and the conductive agent, 5 parts by mass of an ammonium salt of carboxymethylcellulose (CMC) being a dispersant, and 4 parts by mass of polyacrylic acid (PAA: binder) were dispersed in water in the negative electrode slurry preparation. The results are shown in Table 1.

### <<Electrochemical Capacitor A9>>

The electrochemical capacitor A9 was produced and evaluated in the same manner as for the electrochemical capacitors A1 to A7, except that a sodium salt (CMC-Na) was used in place of the ammonium salt of carboxymethyl cellulose in the negative electrode production. The results are shown in Table 1.

### <<Electrochemical Capacitor A10>>

The electrochemical capacitor A10 was produced and evaluated in the same manner as for the electrochemical capacitors A1 to A7, except that acetylene black (AB: specific surface area 70 m²/g) was used in place of Ketjen Black (KB) in the negative electrode production. The results are shown in Table 1.

A comparison of the electrochemical capacitors A1 to A3 with A8 confirmed that the use of PAA in place of styrene-butadiene rubber (SBR) as a binder reduced the amount of generated gas and resulted in good floating characteristics.

A comparison of the electrochemical capacitor A1 with A9 confirmed that the use of CMC-Na resulted in a generally acceptable amount of generated gas and good floating characteristics.

A comparison of the electrochemical capacitor A1 with A10 showed that the use of acetylene black (AB) in place of Ketjen black (KB) reduced the specific surface area of the negative electrode mixture layer by approximately more than half. Such a difference is considered to be influenced by the difference in specific surface area between AB and KB and the difference in structure between AB and KB.

It is considered that gas generation would be suppressed to the same extent as in A1 even when the amount of AB in the electrochemical capacitor A10 was increased so as to achieve a specific surface area equivalent to that of A1. In other words, it can be said that even when AB is used (further, even when a conductive agent other than AB and KB is used), decomposition gas generation can be suppress and floating characteristics can be improved through use of the binder in an amount that results in a ratio to the mass of the negative electrode not exceeding the ratio of the mass of the dispersant to the mass of the negative electrode mixture layer.

### [Evaluation 2: XPS Analysis of Surface of Negative Electrode Mixture Layer]

Analysis of C1s spectrum, O1s spectrum, and Li1s spectrum was performed by XPS on the surface of each of the negative electrode mixture layers after exposure to the carbon dioxide environment. An X-ray photoelectron spectrometer (trade name: Model 5600, product of ULVAC-PHI, Inc.) was used for the analysis. The measurement conditions are indicated below.
X-ray source: Al-mono (1486.6 e V) 14 kV/200 W
Measurement diameter: 800 μm φ
Photoelectron extraction angle: 45° Etching conditions: acceleration voltage 3 kV, etch rate about 3.1 nm/min (as SiO₂ equivalent), raster area 3.1 mm×3.4 mm

The analysis of C1s spectrum, Ols spectrum, and Li1s spectrum confirmed that the thickness of the first layer was approximately 18 nm. Specifically, a peak of, for example, a C—C bond, which is presumed to be impurity carbon, was observed on the outermost surface of the first layer, and it rapidly decreased at a depth of around 1 to 2 nm from the outermost surface of the first layer. By contrast, a first peak attributed to a C═O bond was observed from the outermost surface of the first layer to a depth of 18 nm. A peak attributed to a Li—O bond was also observed from a depth of around 18 nm. Furthermore, the presence of Li was constantly confirmed from the outermost surface of the first layer to a depth of 18 nm. No peaks attributed to LiF were observed.

When the surface of the negative electrode mixture layer of the electrode taken out of each electrochemical capacitor was analyzed by XPS spectrometry in the same manner as described above, it was confirmed that a SEI film (second layer) having a thickness of 10 nm and having a composition that is both different from and distinguishable from that of the first layer was formed. In addition, a peak attributed to LiF was observed.

### INDUSTRIAL APPLICABILITY

The electrochemical capacitor according to the present invention is suitable for in-vehicle use, for example.

### REFERENCE SINGS LIST

100: Electrode body
10: Positive electrode
11x: Exposed portion of positive electrode current collector
13: Positive electrode current collector plate
15: Tab lead
20: Negative electrode
21x: Exposed portion of negative electrode current collector
23: Negative electrode current collector plate
30: Separator
200: Electrochemical capacitor
210: Cell case
220: Sealing plate
221: Gasket

1. An electrochemical capacitor comprising:
a positive electrode;
a negative electrode;
a separator, and
an electrolyte having lithium ion conductivity,
wherein the positive electrode includes a positive electrode current collector and a positive electrode mixture layer that is carried on the positive electrode current collector and that undergoes reversible anion doping,
the negative electrode includes a negative electrode current collector and a negative electrode mixture layer that is carried on the negative electrode current collector and that undergoes reversible lithium ion doping,
the negative electrode mixture layer contains a negative electrode active material, a conductive agent, a binder, and a dispersant, and
a ratio of a mass of the dispersant to a mass of the negative electrode mixture layer is greater than a ratio of a mass of the binder to the mass of the negative electrode mixture layer.

2. The electrochemical capacitor of claim 1,
wherein the binder is at least one selected from the group consisting of fluorocarbon resin, acrylic resin, and a rubber material.

3. The electrochemical capacitor of claim 1,
wherein the binder contains styrene-butadiene rubber.

4. The electrochemical capacitor of claim 1,
wherein the ratio of the mass of the binder to the mass of the negative electrode mixture layer is 0.3% or more and less than 5%.

5. The electrochemical capacitor according to claim 1,
wherein the dispersant is at least one selected from the group consisting of carboxymethylcellulose and carboxymethylcellulose salt.

6. The electrochemical capacitor of claim 1, wherein
the dispersant contains an ammonium salt of carboxymethylcellulose.

7. The electrochemical capacitor of claim 1,
wherein the ratio of the mass of the dispersant to the mass of the negative electrode mixture layer is 1% or more and less than 10%.

8. The electrochemical capacitor of claim 1,
wherein the ratio of the mass of the dispersant to the mass of the negative electrode mixture layer is 3% or more and less than 8%.

9. The electrochemical capacitor of claim 1,
wherein a specific surface area of the negative electrode mixture layer is 10 m²/g or more and 70 m²/g or less.

10. The electrochemical capacitor of claim 1,
wherein the negative electrode mixture layer contains as the conductive agent at least one selected from the group consisting of Ketjen black, acetylene black, and carbon nanotubes.

11. The electrochemical capacitor of claim 1,
wherein a ratio of a mass of the conductive agent to the mass of the negative electrode mixture layer is 2% or more and less than 15%.

12. The electrochemical capacitor of claim 1,
wherein a specific surface area of the conductive agent is 800 m²/g or more.

13. The electrochemical capacitor of claim 1,
wherein the negative electrode active material contains hard carbon.

14. The electrochemical capacitor of claim 1,
wherein a peel strength of the negative electrode mixture layer on the negative electrode current collector is 0.015 N/mm or more.
